(19) United States
(12) Patent Application Publication
(10) Pub. No.: US 2008/0091518 A1
(43) Pub. Date: Apr. 17, 2008

(54) Adaptive cellular network advertising system

(76) Inventors: Henry Eisenson, San Diego, CA (US); Cosmo Barone, Marcus Hook, PA (US)

Correspondence Address: Henry Eisenson, 6106 Via Regla, San Diego, CA, 92122, US

(21) Appl. No.: 11/904,903

(22) Filed: Sep. 28, 2007

Related U.S. Application Data
(60) Provisional application No. 60/848,008, filed on Sep. 28, 2006.

(51) Int. Cl. G06Q 30/00; G06F 17/30; G06F 17/40

(52) U.S. Cl. 705/10

(57) ABSTRACT

A method and software system by which the behavior, economic status, demographic profile, and other data describing cellphone subscribers are captured, stored, and analyzed, then edited and managed by the subscriber to create an accurate subscriber profile. A real-time subscriber monitoring system based upon cellphone location and direction of movement. A system to permit advertisers to target subscribers with messages that are specific to subscriber demography, location, activity, and situation. One variation of the system enables the subscriber to proactively request information about products or services and permits advertisers to respond with targeted messages including the requested information. Another variation permits the subscriber to access weather, sports scores, news, traffic, and similar data, with targeted advertising attached to the information supplied.

### CROSS REFERENCE TO RELATED APPLICATIONS

The present application claims the benefit of priority of U.S. Provisional Patent Application No. 60/848008, filed Sep. 28, 2006 for Henry Eisenson at al. the entire content of which is incorporated herein by reference.

### FIELD OF THE INVENTION

The present invention relates generally to the field of advertising, where a recipient, and a message that is demographically, geographically, behaviorally, and situationally tailored to that recipient, are profitably brought together via the cellular telephone medium.

### FEDERALLY SPONSORED RESEARCH OR DEVELOPMENT

Not applicable

### BACKGROUND OF THE INVENTION

1. Description of the Prior Art

There exist several methodologies by which advertising has been achieved over cellular channels, on cellular telephone displays, and using cellular telephone media.

A search at the USPTO under issued patents for [ABST/“cellular telephone” AND advertising] elicits a list of 36 responses, of which at least three involve some method and/or software and/or system for presenting advertising to the users of cellular handsets. A search under issued and pending patents for [ABST/(“cellular telephone” or “cellular handset”) AND ABST/(promotion or advertising)] elicits only two responses, of which only U.S. Pat. No. 7,010,293 involves an actual advertising methodology.

U.S. Pat. No. 7,010,293 is an intelligent method for capturing, storing, and playing advertisements

20060094410 is a method for correlating the acceptance of advertising with a reduction of cellular service costs

In addition, market research determined that Orange, a cellular service provider in England, was found to offer cellular advertising when the cellphone's integrated Bluetooth function (a short-range wireless transceiver) was proximate to a corresponding merchandiser's Bluetooth transceiver, however this is believed to be Bluetooth-specific, and applies only to cellular handsets that are equipped with that technology. It is not a cellular telephone advertising system, but an advertising system that uses a nonessential accessory to cellular and is therefore not pertinent to the present invention.

The issued patents listed, and many more, were evaluated and found not to reflect the features and capabilities of the present invention. A more comprehensive search may identify existing patents and market usage that in some ways are related to the present invention, or that in some ways attempt to address the opportunities exploited by the present invention, but it is probable that any such U.S. issued or published pending patents would have appeared in the searches defined above and that market usage would have been found by the market research that preceded this application.

Targeted Advertising

Modern advertising depends upon both art and science. The “art” is in the message, which can be comprised of some combination of audio and visual content designed to first capture the attention of the recipient and then stimulate some intended action. The “science” has two components, sociology and technology, and the latter is comprised of many specialties. First, it's critical to analyze and use demographic data to get the right message to the right recipient. Second, the system must cost-effectively manage the process by which that happens.

Successful advertising ensures that the correct promotional messages consistently appear before the demographically and situationally correct recipients, at the right time and in the right place. While most advertising is deemed intrusive, and some advertising is just tolerated, the very best advertising is so precisely correlated with the recipient's interests and needs that it is welcome. That level of correlation (targeting) is rarely achieved by advertisers, and when it is the result is highly profitable.

Existing Solutions for General Advertising

The existing solutions for addressing the “art” requirements of advertising involve enormous creative talent, experience, and skills that produce unique individual intellectual properties comprising promotional campaigns. The success or failure of products often depends upon the content and placement of such advertising, and advertising experts are constantly seeking new ways of getting their messages in front of the correct recipients, at the right time, in the right situation.

Several demographic and sociological sciences work in support of advertising experts to address these requirements, and often know with some exactitude who should see or hear a given message, but the study ends there because there existed no methodology by which even a perfect message, perfectly appropriate to the recipient at a perfect moment, could be delivered.

Modern advertising depends upon statistics; the industry expects that if sufficient messages are sent with sufficient frequency, enough will reach the desired recipients to achieve the intended effect. Messages are mailed, printed in magazines and newspapers, broadcast on television and radio, towed behind airplanes, painted on billboards and sides of trucks, and placed anywhere else that will rent the space and time—all in hope that a given promotional message will be seen by the right persons, at appropriate times. The cost of conventional advertising includes the fact that the vast majority is a failure.

Existing Solutions for Targeted Advertising

The existing solutions for “targeted” advertising includes the compilation of demographically- stratified mailing lists, based upon cross-referenced subscription information, residence location, vehicle registrations, personal licenses, public business records, and similar publicly available data. Such databases produce excellent results and advertising based upon them is more efficient than advertising that is simply broadcast without filtering. However, most such current solutions produce a relatively static result that does not create opportunities for advertisers to appeal to current consumer activity.

The most focused appeals are billboards along highways, erected on the valid assumption that those viewing it can be classified as drivers and passengers in vehicles along that path, approaching some specific exit(s). Considering proximity to urban centers, other assumptions can be made. Similarly, advertising panels along walkways in airports are placed on the valid assumption that about fifty percent of the people passing by are arriving, and are candidates for local hotels and car rental agencies.

Problems with existing advertising systems and methods

One problem with most conventional advertising systems and methods is that many messages are transmitted, printed, broadcast, posted, or otherwise promulgated, but are not seen.

Another problem is that many messages are promulgated and are seen, but not by the correct. recipient.

Another problem is that many messages are promulgated and are seen by the correct recipient, but not at the opportune moment such as to stimulate the response, such as a transaction, intended by the advertiser.

Another problem is that many messages are promulgated and are seen by the correct recipient at the right time, but not at the best location such as to stimulate the response intended by the advertiser.

Another problem is that conventional advertising methods and channels usually involve latency between creation and publication or release of the advertised opportunity and its receipt by the intended recipient.

Another problem of most conventional advertising systems is that the aggregate cost of advertising is elevated due to the above inefficiencies, and advertising cost is embedded in the cost of doing business, which causes a significant increase in the selling price of the services or products offered in the advertising.

One problem with most targeted advertising systems is that they are too static to permit adaptation to the changing circumstances of the consumer.

Another problem with most targeted advertising messages is that they are generally prepared well in advance of the time that the consumer sees or hears them, so it is difficult to convey real-time urgency in the advertising message.

Another problem with most targeted advertising is that those which are closest to real-time can appeal to specific consumer activity and location, but cannot further focus upon a specific consumer profile.

Another problem with most targeted advertising that uses cellular telephones is that it is a one-way system that does not permit the consumer to request information.

While prior art methods, systems, and hardware devices may be suitable to one degree or another for the particular limited requirements they provide to permit targeted advertising on cellular phones, they are not optimum or generalized solutions for targeting consumers, and are not sufficiently flexible to be adaptable to the needs of many potential users.

In these respects, the ADAPTIVE CELLULAR NETWORK ADVERTISING SYSTEM, according to the present invention, substantially departs from the concepts and designs of the prior art. In so doing, the present invention provides unique advantages and opportunities to advertisers, and by presenting purchase opportunities to consumers in a manner that precisely targets their location, time, and demographic situations to generate real opportunities not otherwise possible, serves cellphone subscribers as well.

### OBJECTIVES OF THE INVENTION

In view of the foregoing disadvantages inherent in the known methods and practices for advertising using cellular telephone systems, the present invention provides a substantial divergence from custom to match advertisers and advertisements with the needs of cellular telephone subscribers, in a highly targeted manner, using a unique combination of method, software, and hardware.

The main objective of the present invention is to permit advertisements to appear on the cellular phones of willing participants (subscribers who accept advertising), in a manner that precisely matches the subscriber's profile and activities with the advertising, thus optimizing the targeting of the advertisement with both persistent and transient needs and interests of the subscriber.

Another objective is to increase the percentage of transmitted advertisements that are seen by the consumer, thus improving efficiency of the advertising system and the medium.

Another objective is to correlate the time at which an advertisement is transmitted with the specific activity, location, and behavior of the consumer.

Another objective is to so improve an advertisement's targeting, and therefore efficiency, as to improve the cost of a given result of eliciting a desired response from a consumer.

Another objective is to permit advertisers to dynamically change their messages to fit availability of goods and services, in real time.

Another objective is to provide a means by which a given consumer profile and a given advertiser's message can be matched to optimize results for both.

Another objective is to allow the user to request specific products or services currently offered by advertiser-participants, permitting the communication to be initiated by the subscriber rather than the network.

Another objective is to allow the subscriber to enable advertiser competitors to compete for the subscriber's business in real-time, at specific locations.

Another objective is to allow participating advertisers to exploit advantages when competing against non-participating businesses in presenting real-time opportunities tailored to the cellphone subscriber's specific situation and location.

Another objective of the present invention is to reduce the average per-transaction cost of advertising embedded in cost of the product or service, thus permitting some combination of reduction in cost to the consumer or higher profit to the provider thereof, due to improved efficiency of the communication system and better targeting.

Another objective is to provide advertisers with a new promotional channel of such efficiency, and with such effective targeting, and with such precise timeliness, that it permits a higher level of correlation between the advertising content and the needs of the recipient of the promotional message.

Another objective of the present invention is to enable such targeted and cost-effective advertising while protecting the security of consumer information and providing the consumer with means by which personal information can be held confidential to a level that satisfies the consumer's desire for privacy.

Another objective of the present invention is to enable the development of new consumer behavior information that by itself will be a marketable product that can be sold by the cellular network provider to marketers.

It is the intention of the inventors that these objects apply to all situations involving a cellular telephone advertising system in which advertising messages are transmitted by advertisers via the cellular network to specific users of the cellular telephone handset based upon activity, location, and demography of those specific users.

Other objects and advantages of the present invention will become obvious to the reader and it is intended that these objects and advantages be within the scope of the present invention.

To the accomplishment of the above and related objects, this invention may be embodied in the forms illustrated in the accompanying specification and drawings. However, the specification and drawings are illustrative of the basic concepts only; there are many other possible configurations and derivatives lying within the intended scope of the invention.

### SUMMARY OF THE INVENTION

The present invention consists of a method and software to add new functionality to existing cellular telephone software and hardware. The existing software is comprised of the conventional cellular system management software; all “new” software required by the present invention is appended thereto. The existing hardware is comprised of cellular cell sites, transmission networks, handsets, and associated equipment, plus appropriate interconnection to landline communication systems; “new” hardware is not required by the current expression of the present invention.

The method and software of the present invention includes an internet-based opportunity for advertisers to enter advertising designed for this system, such promotional messages to be time and location specific and transient in nature, and designed to exploit real-time surpluses and opportunities regarding goods and services. Such advertising entries can be automated, or manual via an internet website, but in all cases are focused upon specific locations, time, and situations, and are designed to be matched to specific categories of consumer profiles, locations, and activities.

The method and software of the present invention enables the cellular network to monitor certain long-term behavioral data of the subscriber, such as residence location, work location, work hours, calling patterns, and similarly useful data, to build an activity database or profile useful to enhance the targeting of advertised offers.

The method and software of the present invention includes an internet website-based opportunity for the subscriber to create, edit, and maintain a profile listing preferences, such as to augment, correct, and expand data collected by the network from the subscriber's behavior and maintained automatically by the cellular network computer or associated computer associated with the present invention.

The present invention includes a database that integrates input from the cellular network regarding activity of the subscriber and preferences entered by the subscriber, resulting in an accurate profile that permits optimal targeting of advertised offers by demography and economic characteristics.

In accordance with the present invention, the cellular network will monitor the real-time usage of the cellular phone associated with the participating consumer, such data to include location, route, and other information useful in identifying behavior of the consumer, resulting in accurate real-time data that permits optimal targeting of advertised offers by location, direction, and previously established demographic and economic characteristics.

The present invention includes a unique ring that the subscriber will identify with messages that are associated with precisely targeted advertising, so focused upon the subscriber's behavior and situation that the advertising is welcomed.

The present invention includes the possibility of more than one unique rings, each defining a different priority of advertisement or quality of “match” with the subscriber's profile, thus enhancing the degree of welcome by the subscriber.

In accordance with the present invention, a software matching engine correlates promotions by participating advertisers with the profiles of participating subscribers, and also with the real-time behavior and location of those subscribers, thus permitting the appearance on the participating subscriber's cellphone of only those promotional offers that are specifically targeted to the moment, location, interests, and needs of the subscriber, and that reflect real opportunities and savings available from the advertisers.

The method of the present invention includes an internet-based advertising input system that permits advertiser promotional messages to appear on cellular phones as visual or audio presentations, where the messages are permitted or invited by the cellular phone user by agreement with the cellular service provider. Such acceptance or invitation will be motivated by the focus and timeliness of the messages, which the present invention will ensure are appropriate to the detected moment, location, and behavior.

The software of the present invention provides sufficient information to advertiser participants to support precisely targeted messages, but omits subscriber identity and telephone number to preserve subscriber privacy and security. Instead, advertiser messages will transit from advertiser entry portals (usually a website or data link) through the phone service provider, and only then will be associated with phone numbers for promulgation to targeted subscribers.

The software of the present invention cumulates behavioral data based upon subscriber activity but with subscriber identity removed, in forms that can be sold to marketers and information brokers.

The present invention therefore is comprised of these components;
a) a semi-permanent web-based subscriber user profile that combines information detected by the system based on repetitive subscriber calling and location behavior, such profile to include residential, work, driving patterns, economic, social, hobbies, sports, and other factors that will assist the software of the present invention to match advertising to the subscriber.
b) a means by which the consumer can enter or edit the user profile, opt IN/OUT regarding the program, and set levels of participating and privacy.
c) real-time, transient, behavior monitoring of participating consumers, to facilitate the accurate matching of targeted advertisements based on the location, time, and activity of the subscriber, correlated with that subscriber's semi-permanent profile.
d) an internet-based advertising-entry system for participating advertisers, who then can quickly and simply update their promotions when specific offers are to be made based on transient or geographic circumstances such as a car rental firm's availability of certain models at a specific airport, a restaurant's lack of bookings that evening, a hotel's vacancy rate near a specific exit ramp or downtown location. Advertisements may be entered into the system by manual or automatic processes.
e) real-time detection of a subscriber's entry of specific pro-active interests that can be generated in real-time by a subscriber seeking a product or service not ordinarily matched to that user profile, such request entered using key presses, speech recognition, or another data entry method, to which advertisers can respond with service and product offers tailored to that subscriber's profile, location, and activity.
f) a matching engine within the cellular services provider, or as an ancillary service to that provider, that combines all of the above to optimize the presentation of promotional offers to the subscriber in real time, on the cellular phone, either in a visual display or via audio, or both.
g) speech-recognition interactivity between the subscriber and the system to further refine requests or promotional offers, to increase the probability of a match. Voice requests and voice response via speech recognition will allow an interactive selection by the user of specific products or services of interest.

The method of the present invention also includes the ability of the cellular system to ring the cellular handset when such a message is to be sent to the recipient, such ring to have a unique characteristic so as to be easily recognized as an advertising message and thus permitting the subscriber to accept or decline.

The method also includes the ability of the cellular system to prepend a promotion to an outgoing or incoming telephone call conversation, as a 3-5 second message before the connection is made.

The method also exploits the existing ability of the network to determine the approximate location and direction/rate of movement of the handset at any given time, if the unit is functional and turned “on”. This is achieved by the network's existing determination of the multiple cell(s) to which the handset is reporting, similar to a dynamic Venn Diagram.

The method also exploits the existing ability of the network to determine and record the nature of the businesses to which the handset user makes calls, and thus, over time, to provide a database accessible by the software of the present invention with sufficient data to enable the development of assumptions regarding the handset user's economic status, habits, demography, and other useful data to support targeting. The same data, stripped of user-identification, can be compiled for sale to marketing professionals and information brokers.

The system software of the present invention uses recorded history to determine the approximate locations of the handset user's domicile and place of work, and maintains that record, to permit targeted advertising at each end of the trip, and enroute.

The system software can determine when the handset, and therefore the handset's user, deviate significantly from the user's established pattern of activity, such deviation to include travel, vacation, etc.

The system software is able to determine when the handset is turned “off” or becomes invisible to the network, and when it becomes visible or is turned “on”, and therefore can determine when the handset's user emerges from an aircraft in a terminal, reaches a city from a region not covered by the cellular network, or is traveling along a route from one cell to another.

All available subscriber data, and all advertiser data, are entered into a matching engine by the present invention, which then determines which messages are transmitted to each consumer, and when.

Therefore, the present invention includes a combination of method and software that monitors the patterns of the user, establishes norms, detects deviation from those norms, and for users that have opted to permit targeted advertising provides channels for advertisers whose messages match the user in accordance with known demographic data and specific current behavior, location, and time.

Based upon collected long- and short-term information, the present invention therefore permits the accurate selection and transmission of promotional video, text, and audio messages to the subscriber.

The hardware of the present invention is not necessarily changed from the existing hardware, but future hardware may be modified to further exploit capabilities of the present invention. Evolutionary hardware changes, which are considered part of the present invention, include such features as the ability to generate unique visible alerts (blinking/flashing lights) to indicate arriving advertisements, memory to permit storage of advertisements that cannot be seen/heard in real-time (with automatic deletion based upon validity time codes), and secondary RF proximity sensing and route display to assist the subscriber in navigating to the site transmitting an attractive offer.

Once the fundamental concept is clearly understood, many variations and derivatives will come to mind. All those that exploit the enhanced awareness of the cellular system, monitoring the behavior of the cellphone subscriber, the establishment of norms regarding location and schedules, and the detection of deviation such as to create opportunities by which the system can match the current state of the subscriber with targeted advertising, are considered to fall within the boundaries of this invention.

### DESCRIPTION OF THE PREFERRED EMBODIMENT

The present invention is a method and software that optimizes the delivery of precisely targeted promotional messages from advertisers to the users of enabled cellular telephone handsets.

In the preferred embodiment, the cellular network will detect and compile certain subscriber demographic, economic, travel, work, and home information, and then refer real-time detected activity to that database to detect deviations. The system will enable the subscriber to access the user profile via the internet, and thus to edit and expand the data such as to most accurately reflect the subscriber's interests and preferences.

In the preferred embodiment, the cellular network will monitor the subscriber's activity, location, and other information that can be used to perfect a subscriber profile that permits the system to optimally match advertiser messages to the subscriber's user profile and real-time situation.

In the preferred embodiment, the network will refer the handset user's current situation to a database that characterizes established normal behavior, and identifies deviation from “normal” that create advertising opportunities based on location, circumstances, and time. As an example, the user in a “deluxe” demographic category that exits an airplane at an airport and turns on the handset, might be presented with an opportunity to rent a certain class of vehicle at a special price from a certain rental agency. As another, a handset user some distance from the location known by the system to be “home”, driving on an interstate early in the evening, might see or hear advertising for a hotel suitable to the user's economic stratum.

In the preferred embodiment, participating advertisers will pay the system operator to generate real-time focused advertisements that are geographically specific, and tailored to predictable consumer circumstances. As an example, an airport car rental agency with a surplus of a certain luxury vehicle might wish to promote a special price on that rental opportunity at a specific time, to participating subscribers matched to the opportunity. As another, a hotel at a certain stratum with a surplus of rooms might wish to promote availability to appropriately matched travelers on a specific highway approaching the hotel.

In the preferred embodiment, a matching engine of the present invention will compare subscriber profile data with real-time subscriber activity and location, and make compatibility matches with advertiser offers that are specifically appropriate.

In the preferred embodiment, advertisement:subscriber correlations will result in transmissions to subscribers in the form of visual (image or text) or audio messages.

Therefore, the preferred embodiment consists of a software enhancement of the existing cellular network software management system, as required to capture, store, analyze, and use demographic and behavioral data on cellphone subscribers, a method by which each subscriber can edit and manage that profile, a method that allows advertisers to focus promotions based on subscriber demographics, location, time, and other data such as to correlate messages with significance to the subscriber, and then controlled transmission to the subscriber at a time, in a place, and under circumstances to achieve maximum effectiveness.

### Alternative Embodiments

The present invention also permits the subscriber to solicit advertiser offers via a signal to the system. That is, a subscriber is given the opportunity to request information from the system by a system of key-presses and/or spoken words, thus enabling the cellular network to connect the subscriber to an appropriate advertiser, and eliciting promotional messages and other information that can be tailored to the profile of the subscriber.

### EXAMPLES

A subscriber on a highway may press a key combination that the system associates with the present invention. The network detects that the subscriber is on that specific highway, and determines direction and approximate location. The network then correlates further activity with the subscriber profile, ensuring that offers are appropriate to the tastes, interests, and preferences of the subscriber. The subscriber is presented with a voice menu offering options:

FOR INFORMATION ABOUT SERVICES AT ONCOMING EXITS, PRESS OR SAY “ONE”
A branch menu will ensue, with food, hotel, shopping offers by participating advertisers

FOR OTHER INFORMATION, PRESS OR SAY “TWO”
A branch menu will ensue (car repair, car rental), providing additional offers

A subscriber in a shopping center may press a key combination that the system associates with the present invention. The network detects that the subscriber is in that mall, and presents a voice menu with branching options including types of stores, special pricing, restaurants, and services. The system's matching engine will prioritize promotions to ensure that those most suited to the subscriber's profile are heard first. Participating advertisers will have the opportunity to update their offers in real-time. Advertisers can validate system performance if the offer includes a requirement that the consumer, at the point of purchase, state the means by which the special offer was received.

A subscriber at home can participate. The system will detect that the handset is at home and will respond accordingly, offering a branch menu leading to products and services appropriate for products and services ranging from home repair to food delivery. Participating advertisers will have the opportunity to update their offers in real-time using an automated means or a simple real-time website portal.

A subscriber at work can participate. The system will detect that the handset is at work and will respond accordingly, offering a branch menu leading to products and services appropriate to circumstances and time. If near the lunch hour, offers might include food delivery. During the remainder of the day, offers might include delivery of office supplies.

Subscribers can also request advertiser-supported information, such as traffic, weather, sports scores, and headlines, all of which will be provided but with a prepended few seconds of promotional information that is precisely targeted to that subscriber's profile, in that location, at that time. Audio promotions can be very short and prepended to the first ring in outgoing calls.

### DESCRIPTION OF THE INVENTION

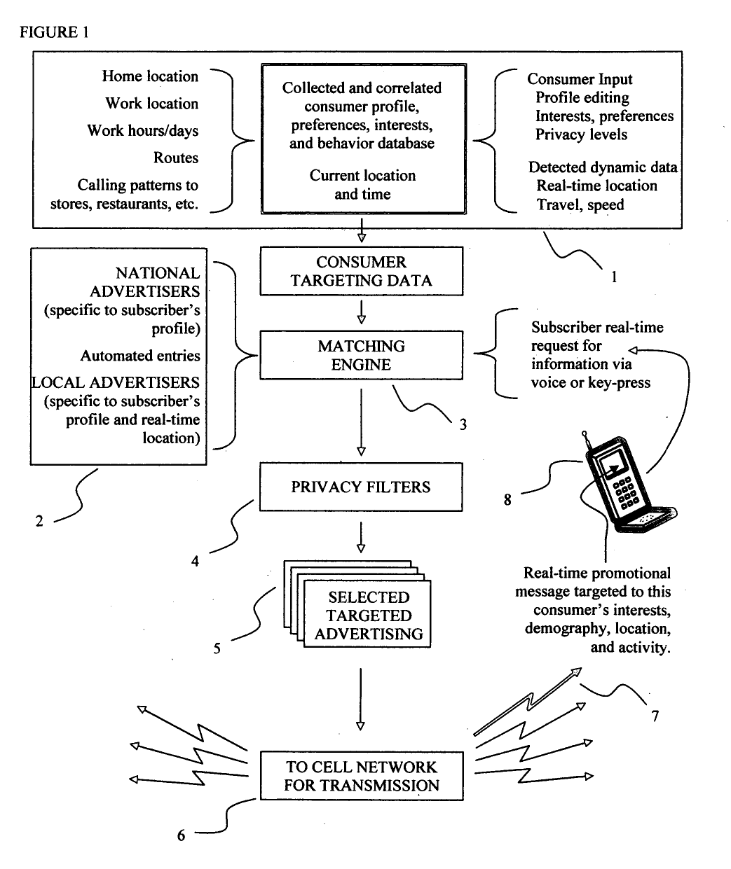

FIG. 1 depicts the present invention in block diagram form, in which a complete consumer profile I is compiled of a combination of consumer input and data detected by the system. Advertisers create their own offerings 2. A matching engine 3 compares consumer profile 1 to advertiser offers 2, and matches are then passed through a privacy filter 4 resulting in selected matches (targeted advertising) 5 being passed to the cellular network 6 for transmission. When a transmitted offer known to match the consumer's preferences 7 is received and displayed by the consumer's cellphone 8, the consumer can respond with key-press or voice to exploit the offer.

We claim:

1. Software and methods comprising an opt-in advertising system that targets cellular phone consumers with real-time promotions that are tailored to the consumer's interests, behaviors, location, and activities, comprised of;
i) an internet website on which the cellular service provider establishes the profile of participating consumers;
ii) a means by which consumers can find and manage his/her profile;
iii) cellular system software that maintains a database indicating the participating consumer's interests, behaviors, real-time location, and activities;
iv) a website or communication channel on which participating advertisers can manually or automatically list overstock inventory or underbooking conditions and sales offers;
v) a software matching engine that compares data from phone consumers and advertisers;
vi) a communication method that generates real-time cellular messages to participating consumers that propose purchase or activity opportunities based upon said matches;
vii) an interactive cellular communication method that permits the consumer to act upon such proposed opportunities quickly and efficiently; and
viii) conventional software to provide accounting and collection, manipulation, and reporting of consumer data.

2. The system of claim 1 wherein the cellular service provider develops and maintains a profile for each phone consumer that has opted into said program, wherein multiple profiles of consumers constitute a database defining a market of multiple participants.

3. The database subsystem of claim 2 wherein each consumer profile contains consumer-generated interests, plans, and preferences.

4. The database subsystem of claim 2 wherein each consumer profile contains system-generated data defining the consumer behavior, communication patterns, location, direction and rate of travel, and historical response patterns to previous advertising.

5. The database subsystem of claim 2 wherein a port provides password-protected electronic access by the consumer, thus permitting changes in preferences, interests, and other key marketing data, and permitting permanent or temporary opt-in and opt-out decisions to be registered.

6. The accessible and password-protected database subsystem of claim 5 wherein the port available to consumers is an internet website.

7. The accessible and password-protected database subsystem of claim 5 wherein the port available to consumers is a cellular connection.

8. The method and software of claim 1 wherein an advertiser opportunity database is provided, permitting advertisers at a national or local level to list overstocked inventory, underbooked hotel/restaurant/resort/services, all in real time.

9. The database of claim 8 wherein participating advertisers are provided a port permitting the opportunity database to be entered automatically via secure automated data communication and thereby list opportunities either locally, regionally, or nationwide.

10. The database of claim 8 wherein participating advertisers are provided a port such as an internet website, via which the opportunity database can be accessed manually via password to permit real-time and local promotions to be listed.

11. A data matching engine that can compare consumer profiles, behavior, location, direction and rate of travel per claim 4 with the advertiser opportunity database of claim 8, generating matches between consumer interests and situations and advertiser promotions.

12. A communication link to the consumer cellphone, which will alert a given consumer that the matching engine of claim 11 has matched his/her consumer profile of claim 4 with an advertiser-generated opportunity of claim 8.

13. The alert of claim 12, wherein a unique ring or signal alerts the consumer that the call is a message generated by the opt-in cellular advertising system.

14. An opportunity for the consumer to respond via cellular to alerts generated by claims 12 and 13 by pushing a button on the cellphone to notify the cellular system of the consumer's interest in a displayed promotion opportunity.

15. The system of claims 1-14 wherein speech-recognition-based interactivity is added between the cellular network and the consumer to permit refinement of communication, voice requests, and interactive selection or acceptance, or rejection, of promoted products and services.

16. The system of claims 1-15 wherein accounting software can capture and record consumer activity correlated with advertised targeted opportunities, permitting the cellular service provider or other entity that operates the system of claims 1-15 to bill advertisers accordingly.

17. The system of claims 1-15 wherein accounting software permits cellular service rate reductions as an inducement to consumers to participate, or opt in, to the system.

18. The system of claims 1-15 wherein an accounting and data-compilation method and software permits the compilation of information collected by the system mechanisms and processes, the removal of unique consumer identification, and the creation of statistical data that is suitable for sale to marketing professionals and information brokers.

19. The method and software of claims 1-15 wherein consumer billing includes a listing of advertising presented in the previous billing period, with a means by which the consumer can modify his/her profile and improve the fit between personal interests and available promotions.

20. The method and software of claims 1-18 wherein feedback to the operators of the system supports continuous optimization of the process, methods, and software comprising it.
